(19) United States
(12) Patent Application Publication
(10) Pub. No.: US 2006/0026108 A1
(43) Pub. Date: Feb. 2, 2006

(54) Voice/data financial transaction monitoring methods and systems

(76) Inventors: Paul Wilson, Suwanee, GA (US); Barry Danz, Alpharetta, GA (US)

Correspondence Address: BAMBI FAIVRE WALTERS, PO BOX 5743, WILLIAMSBURG, VA, 23188, US

(21) Appl. No.: 10/903,737

(22) Filed: Jul. 30, 2004

(51) Int. Cl. G06F 17/60

(52) U.S. Cl. 705/78

(57) ABSTRACT

Financial transaction monitoring methods and systems enable processing, communicating, monitoring, and/or otherwise managing a financial transaction among a voice/data financial transaction communications device, a financial institution authorization communications address, a cardholder communications device, a third party communications address, and/or a peripheral device via a communications network. A financial transaction request is detected and is used to generate a financial monitoring communications signal to a cardholder and/or third party communications device. The financial monitoring communications signal may present a notification of the financial transaction, prompt for a response to the request, prompt to receive further communications, and/or prompt to request surveillance data of a peripheral device.

### CROSS REFERENCE TO RELATED APPLICATIONS

This application relates to applicants' co-pending application entitled “Voice/Data Financial Transaction Communications Device” Ser. No. ______ (BS030578, 04-BS010) filed simultaneously herewith and of which the “Brief Summary of the Invention” and “Detailed Description of the Invention” sections are incorporated herein by this reference.

This application relates to applicants' co-pending application entitled “Financial Transaction Processing Via Combined Voice/Data Financial Transaction Communications Device and Call Control and Service Logic System” Ser. No. ______ (BS040090, 04-BS015) filed simultaneously herewith and of which the “Brief Summary of the Invention” and “Detailed Description of the Invention” sections are incorporated herein by this reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention generally relates to Internet telephony, and, more particularly relates to systems and methods for interactive communications with a Voice-Over Internet Protocol financial transaction communications device over a data communications network and/or a telecommunications network.

2. Description of Related Art

Internet Telephony also referred to herein as Voice-Over Internet Protocol (VoIP), Voice-Over Network (VoN), and/or Internet Protocol Telephony (IP Telephony), is experiencing explosive growth and marked improvements in reliability and sound quality. The improved Internet Telephony communications are, in large part, due to upgrading the internet backbone with better switching fabrics, such as Asynchronous Transfer Mode (ATM), and also due to implementation of new communications standards, such as standards for transport protocols, directory services, and/or audio codec format.

These improvements and growth of IP telephony are greatly influencing the integration (and/or internetworking) of traditional telecommunications networks, such as the Public Switched Telephone Network (PSTN) with the data networks, such as the Internet Protocol (IP) Network. Conventional voice technology (e.g., a Plain Old Telephone (POTS) call) processes the analog communications signal over a circuit-switched telecommunications network, however with advances in IP telephony, voice technology is reaching towards a packet-switched data network. Rather than risking just “jumping” over to the IP-based communications network that still faces many engineering and distribution challenges, communications providers (e.g., telecommunications service providers, internet service providers, and so on) use a hybrid network that relies on proven performance and a large distribution of the Public Switched Telephone Network (PSTN) with the IP-based network to leverage the assets of both networks.

Along with these improvements come new challenges for the industry. For example, a need exists for better, more efficient and secure financial transactions from an Internet telephony communications device. Today, most merchants process financial transactions with an ATM/debit/credit card processing service to receive payment from a customer. Equipment for the ATM/debit/credit card processing service typically includes a terminal, an analog phone, and a router. When the customer makes a purchase (e.g., buys groceries, gas, and so on) and uses a credit, debit, or ATM card (hereinafter referred to as a “credit card”), the customer typically swipes, inserts, and/or otherwise presents a magnetic reader of his/her card to a credit card processing terminal at the point of sale (POS). The credit card terminal device reads the magnetic reader, dials an associated card authorization number, routes and communicates a payment request to the credit card's authorization center via the PSTN, and then communicates a response to the request (e.g., approval or denial) from the credit card's authorization center to the terminal. This authorization process sometimes encounters a variety of problems including errors reading the credit card, hardware and equipment malfunctions, and communications problems. For example, if a router that connects multiple terminals at check out counters (POS) in a grocery store malfunctions, then no credit card transactions can be processed from any of the terminals until the router is fixed. Consequently, the grocery store may lose money when customers become frustrated or do not have another payment alternative. Additionally, today's credit card processing equipment tends to be somewhat large and bulky, taking up counter space that could be used to promote merchandise, and consequently lead to other financial losses.

Accordingly, systems and methods are needed for a credit card authorization process from a VoIP communications device over data networks and/or telecommunications networks. Additionally, methods and systems that provide increased efficiency, notification, and/or security are further needed for these VoIP credit card related financial transactions.

### SUMMARY OF THE INVENTION

This invention addresses the above needs and other needs by providing systems, methods, computer programs, and/or computer program products to process, monitor, and communicate a financial transaction request from of voice/data financial transaction communications device to a cardholder communications device and/or a third party communications device. This invention, in particular, provides a voice/data financial transaction communications device equipped with a VoIP financial transaction communications computer software product. According to some of the exemplary embodiments of this invention, the VoIP financial transaction communications computer software product (also referred to herein as the “VoIP Financial Transaction Monitoring Module”) receives data of a financial card medium (e.g., Visa, MasterCard, debit cards, gift cards, store credit, and so on) from a card reader subsystem in its credit card processing terminal, then analyzes and associates the card's financial data with transactional data to create a financial transaction request. Thereafter, the financial transaction request is communicated to a financial institution authorization communications address via a communications network. The financial transaction request further triggers the VoIP Financial Transaction Monitoring Module to generate a financial monitoring communications signal to a cardholder communications device and/or a third party communications device such that a party receiving the financial monitoring communications signal may receive notification of the financial transaction request, confirm authorization of the financial transaction request, select to monitor financial transaction communications, select to override a response from the financial institution authorization communications address, and/or request surveillance data associated with the financial transaction. Thereafter, the VoIP Financial Transaction Monitoring Module initiates communication of the financial monitoring communications signal to the cardholder communications device and/or the third party communications device. According to further embodiments, the cardholder communications device and/or third party communications device may respond to the financial transaction monitoring communications signal to confirm authorization, to select to monitor further communications, to override the response from the financial institution authorization communications address, to request surveillance data, to terminate the notification, and/or other financial transaction processing. According to still further embodiments, the VoIP Financial Transaction Monitoring Module may receive the request for surveillance data, and then access, activate, and/or deactivate surveillance hardware, equipment, and/or data, and communicate the surveillance data to the cardholder communications device and/or third party communications device. Alternate embodiments provide other systems and methods to detect the financial transaction request and, in response, generate the financial monitoring communications signal for communications with the cardholder communications device and/or third party communications device. For example, the communications network and/or the financial institution authorization communications address may detect the financial transaction request from the voice/data financial transaction communications device, and in response, generate and communicate the financial monitoring communications signal to the cardholder communications device and/or third party communications device.

According to exemplary embodiments of this invention, a method for monitoring a financial transaction request from a voice/data financial transaction communications device includes detecting the financial transaction request from the voice/data financial transaction communications device to a financial institution authorization communications address, generating a financial monitoring communications signal, and communicating the financial monitoring communications signal to a cardholder communications device and/or a third party communications device. Typically, the financial transaction request includes merchant data, merchandise data, a monetary amount of the financial transaction, and data of a financial card medium read by a cardreader subsystem of the voice/data financial transaction communications device. For example, the financial card medium data may include financial institution authorization communications address, a card identifier, and expiration date, a monetary limit for a financial transaction, a cardholder identifier, a cardholder communications address, a third party identifier, a third party communications address. And, the merchant data may include a merchant identifier, a merchant communications address, a financial institution associated with the merchant and a communications address for the merchant financial institution, and payment preferences of the merchant. The financial monitoring communications signal that is communicated to the cardholder and/or to the third party may present a notification of the financial transaction request, prompt the cardholder and/or third party for a response to the request (e.g., a confirmation, denial, or alternate message from the cardholder and/or third party), prompt to receive communications of additional data of the financial transaction, prompt to request surveillance data of a peripheral device, and/or prompt for further financial transaction processing. If the cardholder and/or third party responds to the request, then this response is communicated to the voice/data financial transaction communications device and/or to the financial institution authorization communications address for confirmation, denial, and/or alternate processing of the financial transaction request. If the cardholder and/or third party requests additional communications of the financial transaction, then these additional communications are communicated to the cardholder and/or third party communications device. And, if the cardholder and/or third party requests surveillance data, then a surveillance communications signal is communicated with the peripheral device to access data of the peripheral device, activate and/or deactivate the peripheral device, and/or otherwise manage the peripheral device such that the cardholder and/or third party communications device receives the requested surveillance data.

According to other exemplary embodiments of this invention, a voice/data financial transactions communications system includes a voice/data financial transaction communications device having a card reader subsystem, a VoIP financial transactions monitoring module stored in memory, a processor communicating with the memory, and a communications network. The VoIP financial transactions monitoring module includes a computer program product that accesses and associates financial data with transactional data to create a financial transaction request and a financial monitoring signal, and, thereafter, to initiate communications of the financial monitoring signal to a cardholder and/or third party communications device. The financial card medium data includes a financial institution authorization communications address, a card identifier, an expiration date, a monetary limit for a financial transaction, a cardholder identifier, a cardholder communications address, and/or a third party communications address. The transactional data includes merchant data, such as, a merchant communications address, a merchant identifier, and/or a financial institution of the merchant, and also includes data identifying a good and/or service of the financial transaction and/or identifying a monetary amount of the financial transaction. The communications network establishes a communications connection among at least two of the voice/data financial transaction communications device, the financial institution authorization communications address, the cardholder communications device, the third party communications device, and/or peripheral equipment such that the cardholder and/or third party communications device is notified of the financial transaction request to the financial institution communications address and may access and act on data of the financial transaction request. And, in some instances, the cardholder communications device and/or third party communications device may access, activate, deactivate, and/or otherwise manage peripheral surveillance equipment. According to some embodiments, either a router or a call control and service logic center communicates the financial transaction monitoring communications signal to the cardholder communications address and/or third party communications address via a communications network, such as, for example, a telecommunications network (e.g., Public Switched Telephone Network (PSTN)), a data communications network (e.g., an Internet Protocol communications network), and/or a satellite network. In response to receiving the financial monitoring signal, the cardholder and/or third party may confirm authorization of the financial transaction request, override an instruction to cancel an authorization of the financial transaction request, select to further monitor communications among the voice/data financial transaction communications device and the financial institution authorization communications address, request surveillance data of the peripheral device, and/or further process the financial transaction. If the cardholder and/or third party responds to the financial monitoring signal, this response is communicated to either the VoIP Financial Transaction Monitoring Module and/or to a communications address of the peripheral equipment. For example, if the cardholder confirms authorization of the financial transaction request, then this authorization confirmation may be communicated back to the VoIP Financial Transaction Monitoring Module to process with a response of the financial institution authorization communications address and to complete the financial transaction.

According to still other exemplary embodiments of this invention, a computer program product includes a computer readable medium and a VoIP Financial Transaction Monitoring Module stored on the computer readable medium. The VoIP Financial Transaction Monitoring Module detects a financial transaction request and generates a financial monitoring communications signal. Similar to above, the financial transaction request includes a financial institution authorization communications address, a card identifier, an expiration date, a monetary limit for a financial transaction, a cardholder identifier, a cardholder communications address, a third party identifier, a third party communications address, merchant data, a description of the goods and/or services of the financial transaction, and/or a monetary amount. And, the financial monitoring communications signal may include the financial transaction request, a confirmation parameter to confirm authorization of the financial transaction request, a monitoring parameter for monitoring communications of the financial transaction request, a control parameter for overriding an authorization from the financial institution authorization communications address, a peripheral control parameter for communicating with a peripheral device to access surveillance data of the financial transaction, and/or another parameter to further process the financial transaction.

Other systems, methods, and/or computer program products according to embodiments of this invention will be or become apparent to one with skill in the art upon review of the following drawings and detailed description. It is intended that all such additional systems, methods, and/or computer program products be included within this description, be within the scope of this invention, and be protected by the accompanying claims.

### BRIEF DESCRIPTION OF THE DRAWINGS

The above and other embodiments, objects, uses, advantages, and novel features of this invention are more clearly understood by reference to the following description taken in connection with the accompanying figures, wherein:

FIG. 1 illustrates a block diagram of an operating system according to some of the exemplary embodiments of this invention;

FIG. 2 illustrates an operating environment for processing and/or otherwise monitoring financial transactions according to some of the exemplary embodiments of this invention;

FIG. 3 illustrates another example of an operating environment for processing and/or otherwise monitoring financial transactions according to some of the exemplary embodiments of this invention;

FIG. 4 illustrates another operating environment for processing and/or otherwise monitoring financial transactions according to some of the exemplary embodiments of this invention;

FIG. 5 illustrates another example of an operating environment for processing and/or otherwise monitoring financial transactions according to some of the embodiments of this invention;

FIG. 6 illustrates another example of an operating environment for processing and/or otherwise monitoring financial transactions according to some of the embodiments of this invention;

FIG. 7 illustrates another example of an operating environment for processing and/or otherwise monitoring financial transactions according to some of the embodiments of this invention;

FIG. 8 illustrates another example of an operating environment for processing and/or otherwise monitoring financial transactions according to some of the embodiments of this invention;

FIG. 9 illustrates another block diagram of an alternative operating system according to exemplary embodiments of this invention; and

FIG. 10 illustrates a flowchart of a method for processing and/or otherwise monitoring financial transactions according to exemplary embodiments of this invention.

### DETAILED DESCRIPTION OF THE DRAWINGS

This invention now will be described more fully hereinafter with reference to the accompanying drawings, in which exemplary embodiments are shown. This invention may, however, be embodied in many forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, flowcharts, illustrations, and the like represent conceptual views or processes illustrating systems, methods, and computer program products embodying this invention. The functions of the various elements shown in the figures may be provided through the use of dedicated hardware, as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

This invention provides methods, systems, and computer program products for processing, communicating, monitoring, and/or otherwise managing a financial transaction between a voice/data financial transaction communications device, a financial institution authorization communications address, a cardholder communications device, a third party communications address, and/or a peripheral device via a communications network. According to some of the exemplary methods and systems of this invention, a financial transaction request from a voice/data financial transaction communications device to a financial institution authorization communications address is detected and is used to generate a financial monitoring communications signal for communication to a cardholder communications device and/or a third party communications device. When the financial monitoring communications signal is communicated to the cardholder and/or to the third party communications device, the cardholder and/or third party communications device may present a notification of the financial transaction request, prompt the cardholder and/or third party for a response to the request (e.g., a confirmation, denial, or alternate message from the cardholder and/or third party), prompt to receive communications of additional data of the financial transaction, prompt to request surveillance data of a peripheral device, and/or prompt for additional financial transaction processing. If the cardholder and/or third party responds, then this response may be communicated to the voice/data financial transaction communications device, the financial institution authorization communications address, and/or the peripheral device for confirmation of, denial of, and/or alternate processing of the financial transaction communications request and/or for access to, activation of, deactivation of, and/or other management of the peripheral device. For example, if the cardholder and/or third party requests additional communications for the financial transaction, then these additional communications are communicated to the cardholder and/or third party communications device. And, if the cardholder and/or third party requests surveillance data, then a surveillance communications signal is communicated to the peripheral device to access data, activate and/or deactivate, and/or otherwise manage the peripheral device such that the cardholder and/or third party communications device receives the requested surveillance data. The financial monitoring communications signal and/or any responses to the financial monitoring communications signal are communicated via a communications network (e.g., data network, telecommunications network, mobile switching telephone network, satellite network, and so on). In still further embodiments, a computer software product (e.g., the VoIP Financial Transactions Monitoring Module) may further process the financial monitoring communications signal and/or any responses to complete the financial transaction.

The voice/data financial transaction communication monitoring system provides a creative, integrated, and secure communications solution that incorporates conventional credit card processing equipment with the communication assets of a VoIP phone and that provides the means for interactive communications of the financial transaction among the voice/data financial transaction communications device, the financial institution authorization communications address, a communications address to the peripheral device, the cardholder communications device, and/or the third party communications device. For example, a daughter of a cardholder may use her parent's credit card (e.g., VISA, AMEX, and so on) to pay for gas at a “pay at the pump” gas station. When, the daughter swipes or otherwise enters the credit card to a cardreader subsystem of a voice/data financial transaction communications device, a voice/data financial transaction monitoring module detects a financial transaction request, then creates a financial monitoring communications signal, and communicates the financial monitoring communications signal to the mother's communications device, such as a home telephone and/or a cellular telephone (i.e., the cardholder communications address). When the mother receives the financial monitoring communications signal via the home telephone and/or the cellular phone, the mother is notified of the financial transaction request and may confirm or otherwise respond to the request. In addition, the mother may request surveillance data to aide in her response. For example, if the gas station has video surveillance equipment, then the financial monitoring communications signal may identify the video surveillance equipment and prompt the mother to receive the surveillance data of the video surveillance equipment. The surveillance data may present a digital picture of the daughter at the pump so that the mother can identify her daughter and further authorize the request. In some embodiments, the computer software product (e.g., the VoIP Financial Transaction Monitoring Module) may further instruct a printer to print a receipt or other documentation of the financial transaction. And, this printer may be integrated and/or otherwise couple with the cardholder communications device and/or the third party communications device. In the above example, the mother may request that the gas receipt print to a printer associated with her home telephone number and/or cellular number. Alternatively, the documentation of the financial transaction may also be communicated to another communications address of the cardholder and/or the third party, such as to an email address. And, the documentation of the financial transaction may be customized and/or otherwise formatted for the receiving communications device by the VoIP Financial Transaction Monitoring Module.

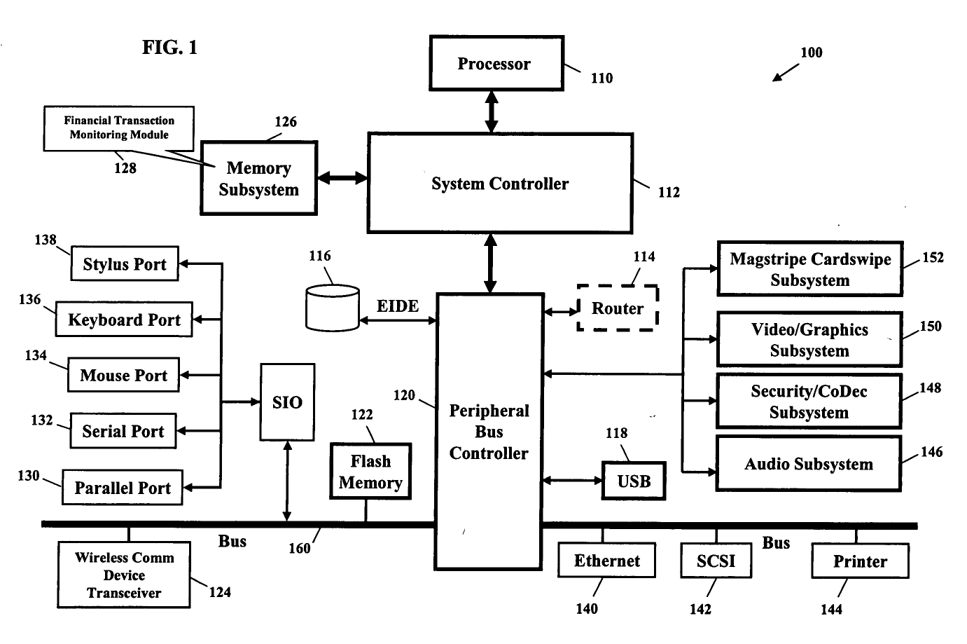

Referring now to the figures, FIG. 1 illustrates an operating system according to some of the embodiments of this invention. FIG. 1 is a block diagram showing a VoIP Financial Transaction Monitoring Module 128 residing in a computer system shown as a voice/data financial transaction communications device 100. As FIG. 1 shows, the VoIP Financial Transaction Monitoring Module 128 operates within a system memory device. The VoIP Financial Transaction Monitoring Module 128, for example, is shown residing in a memory subsystem 126. The VoIP Financial Transaction Monitoring Module 128, however, could also reside in flash memory 122 or a peripheral storage device 116. The voice/data financial transaction communications device 100 also has one or more central processors 110 executing an operating system. The operating system, as is well known in the art, has a set of instructions that control the internal functions of the voice/data financial transaction communications device 100. A router 114 may be incorporated into the voice/data financial transaction communications device 100 to communicate a communications signal (e.g., a financial monitoring communications signal, a financial transaction request, an authorization, and/or other communications) among the voice/data financial transaction communications device 100 and a cardholder communications device and/or a third party communications device and/or an alternate communications address (e.g., an incoming/outgoing phone call, an incoming/outgoing email, a financial institution authorization communications address, a communications address of a peripheral device, and so on). As understood by those of ordinary skill in the art, the router 114 operates with a peripheral bus controller 120 of the voice/data financial transaction communications device 100.

The system controller 112 (typically called the “Northbridge”) provides a bridging function between the one or more central processors 110, a memory subsystem 126, and the peripheral bus controller 120. The peripheral bus controller 120 (typically called a “Southbridge”) controls the PCI (Peripheral Controller Interface) bus 160 and is an integrated circuit that serves as an input/output hub for the router 114, a video/graphics subsystem 150, a magstripe card swipe subsystem 152, a security/CoDec subsystem 148, an audio subsystem 146, and for various peripheral ports and/or transceivers. These peripheral ports allow the voice/data financial transaction communications device 100 to communicate with a variety of devices, with a call control and service logic system, and/or with a communications network through networking ports, such as SCSI 142 or Ethernet 140, and/or transceivers that include wireless communications (“comm”) device transceiver 124 (for wireless communications of any frequency signal in the electromagnetic spectrum, for example, wireless 802.11 and infrared). These peripheral ports could also include other networking ports, such as a serial port 132, a parallel port 130, a mouse port 134, a keyboard port 136, and/or a stylus port 138. The PCI 160 further integrates and/or communicates with a printer 144 for printing receipts and/or other documentation of a financial transaction.

Those of ordinary skill in the art also understand the central processor 110 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described in this patent are not limited to any particular manufacturer's central processor.

The operating system may be a UNIX® operating system (UNIX®E is a registered trademark of the Open Source Group, www.opensource.org). Other UNIX-based operating systems, however, are also suitable, such as LINUX® or a RED HAT® LINUX-based system (LINUX® is a registered trademark of Linus Torvalds, and RED HAT® is a registered trademark of Red Hat, Inc., Research Triangle Park, N.C., 1-888-733-4281, www.redhat.com). Other operating systems, however, are also suitable. Such other operating systems would include a WINDOWS-based operating system (WMDOWS® is a registered trademark of Microsoft Corporation, One Microsoft Way, Redmond Wash. 98052-6399, 425.882.8080, www.Microsoft.com) and Mace OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described in this patent are not limited to any particular operating system.

The router 114, if incorporated into the voice/data financial transaction communications device 100, may be a Netopia® 3300-ENT Series (Netopia® is a registered trademark of Netopia Corporation, Market Place Tower, Emeryville, Calif. 94608, www.netopia.com). Additionally, other suitable routers by various manufacturers that are known to those of ordinary skill may be used, and therefore will not be further discussed.

The system memory device (shown as memory subsystem 126 and/or peripheral storage device 116) may also contain an application program. The application program cooperates with the operating system and with a display unit to provide a graphical user interface (GUI). The graphical user interface typically allows a user to input a combination of signals (such as signals communicated from the audio subsystem 146, the video/graphics subsystem 150, the magstripe card swipe subsystem 152, and/or signals from one or more of the peripheral ports, such as the keyboard port 136, and/or alternative input devices). The graphical user interface provides a convenient visual and/or audible interface with the voice/data financial transaction communications device 100 so that a user is presented information to the voice/data financial transaction communications device and/or facilitates input and/or other communications of user information.

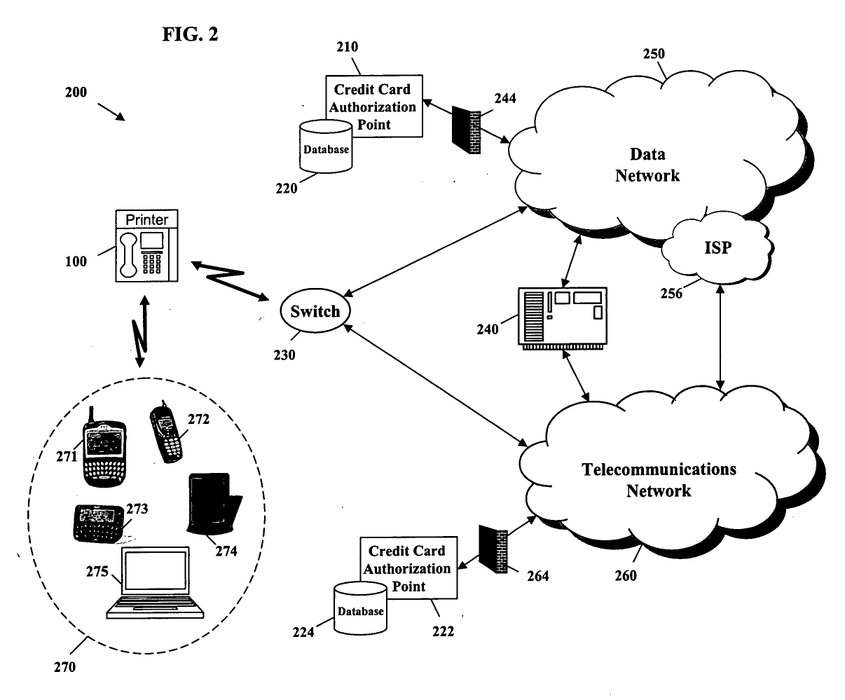

FIG. 2 illustrates an operating environment for monitoring voice/data financial transactions 200 that includes the voice/data financial transaction communications device 100 of FIG. 1, a voice/data communications switch 230, a data communications network 250, a firewall 244, a financial institution authorization communications address 210 (also referred to herein as “credit card authorization address,” “financial institution communications address,” or “credit card authorization point”) having a database 220, an Internet Service Provider (ISP) 256, a Voice XML Gateway 240, a telecommunications network 260, another firewall 264, another financial institution authorization communications address 222 having a database 224, and one or more wireless communications devices 270 associated with a cardholder and/or a third party. As shown in FIG. 2, the communications devices 270 include a VoIP phone 271, a cellular phone 272, a pager 273, a personal digital assistant (PDA) computing device, and a laptop computer 275. Typically, the VoIP financial transaction communications monitoring module (shown as reference numeral 128 of FIG. 1) of the voice/data financial transaction communications device 100 detects a financial transaction communications request (also referred to herein as a “financial transaction request”) for communication with/to the financial institution authorization communications address 210 and/or 222, and, in response to detecting the financial transaction request, the financial transaction communications monitoring module generates a financial transaction monitoring communications signal and initiates communication of the financial transaction monitoring communications signal to the one or more wireless communications devices 270 associated with the cardholder and/or third party. As used herein, the term “financial transaction request” includes the financial institution authorization communications address 210 and/or 222, a cardholder identifier (e.g., the cardholder's name, billing address, billing phone number, rating, and/or other information), a cardholder communications address, a third party identifier (e.g., the third party's name, title, and/or responsibility to a financial transaction), a third party communications address, an expiration date, a monetary limit for a financial transaction, data identifying a merchant, such as a merchant communications address, a merchant identifier (e.g., the merchant's name, business address, rating, and/or other information), data of a financial institution of the merchant, and/or payment preferences of the merchant, data identifying a good and/or service of the financial transaction, data identifying a monetary amount of the financial transaction, and/or other financial transaction data. And, as used herein the term “financial transaction monitoring communications signal” includes data of the financial transaction request, a financial transaction control parameter to prompt the cardholder and/or third party for a response to the request (e.g., a confirmation, denial, or alternate message from the cardholder and/or third party), a financial transaction communications parameter to prompt the cardholder and/or third party to receive communications of additional data of the financial transaction, a surveillance parameter to prompt the cardholder and/or third party to request surveillance data of a peripheral device, and/or a processing parameter to prompt the cardholder and/or third party for additional financial transaction processing. Additionally, the financial transaction request and/or the financial transaction monitoring communication signal may include data, voice, audio, text, and/or visual communication signals that are known in the art and will not be further explained.

According to embodiments of this invention, the peripheral bus controller (shown in FIG. 1 as reference number 120) operates with the VoIP financial transaction monitoring module (shown in FIG. 1 as reference number 128) and with router 114 to control communications of the financial transaction monitoring communications signal to the one or more local wireless communications devices 270 associated with the cardholder and/or third party. That is, for example, the router 114 may directly transmit the financial transaction monitoring communications signal to a wireless communications address of the one or more devices 270. For example, a cardholder's wireless communications device (e.g., VoIP phone 271) located in proximity to the voice/data financial transaction device 100 may receive a direct, wireless communication of the financial transaction monitoring communications signal from router 114. Alternatively, the wireless communications device transceiver 124 described in FIG. 1 may also communicate a wireless communications signal to the one or more local, wireless communications devices 270. The communications signaling, connections, and/or logic among the voice/data financial transaction communications device 100 and the one or more wireless communications devices 270, however, are well understood in the art and will not be further described.

The service for communication of the financial transaction monitoring signal to the cardholder and/or third party communications device is referred to as the “financial transaction monitoring service,” and may be configured and/or otherwise managed by a credit card owner (e.g., the cardholder) and/or a credit card company so that the cardholder and/or a third party is selectively notified of a financial transaction request and may respond to the request as further described in the examples below. For example, if a mother lends her credit card to her child for a college semester, she may select to have all financial transactions (e.g., charges to the account, credits to the account, access of the account, such as a balance inquiry) authorized by her, such that the financial transaction monitoring service of her card is “on” or in an active state until she selects the service to be turned “off.”

In response to communicating the financial monitoring communications signal, the cardholder and/or third party may communicate (1) a confirmation and/or co-pending authorization for the financial transaction request, (2) a selection to monitor further communications with the financial institution authorization address, (3) an override instruction to cancel the authorization of the financial transaction request, (4) a request for surveillance data, and/or (5) a request for additional financial transaction processing. For example, one of the local, wireless communications devices 270 may receive and present the financial transaction monitoring communications signal, such as a graphical communication to the VoIP phone 271, and in response, the cardholder may authorize the transaction. The authorization is communicated back to the voice/data financial transaction communications device 100 and may be further communicated to the financial institution authorization communications address 210 and/or 22 or may be reconciled by the voice/data financial transaction communications device 100 with a response from the financial institution authorization communications address 210 and/or 222. That is, for example, if the cardholder authorizes the transaction, but the financial institution does not authorize the transaction, then the financial transaction request is denied. According to further embodiments, this denial may be communicated to the local, wireless communications device 270 so that the cardholder and/or third party is notified and/or may further process the financial transaction request (e.g., provide an alternate payment means)

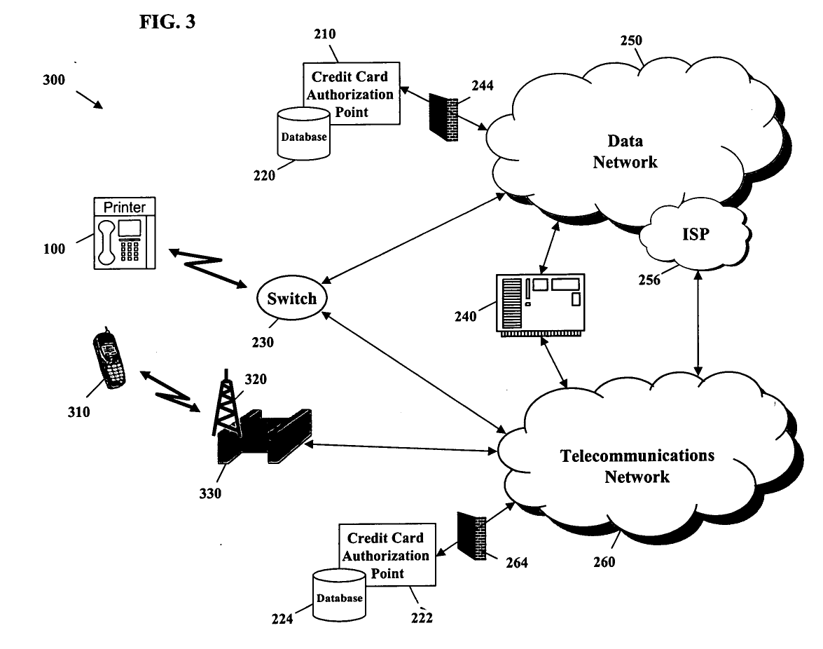

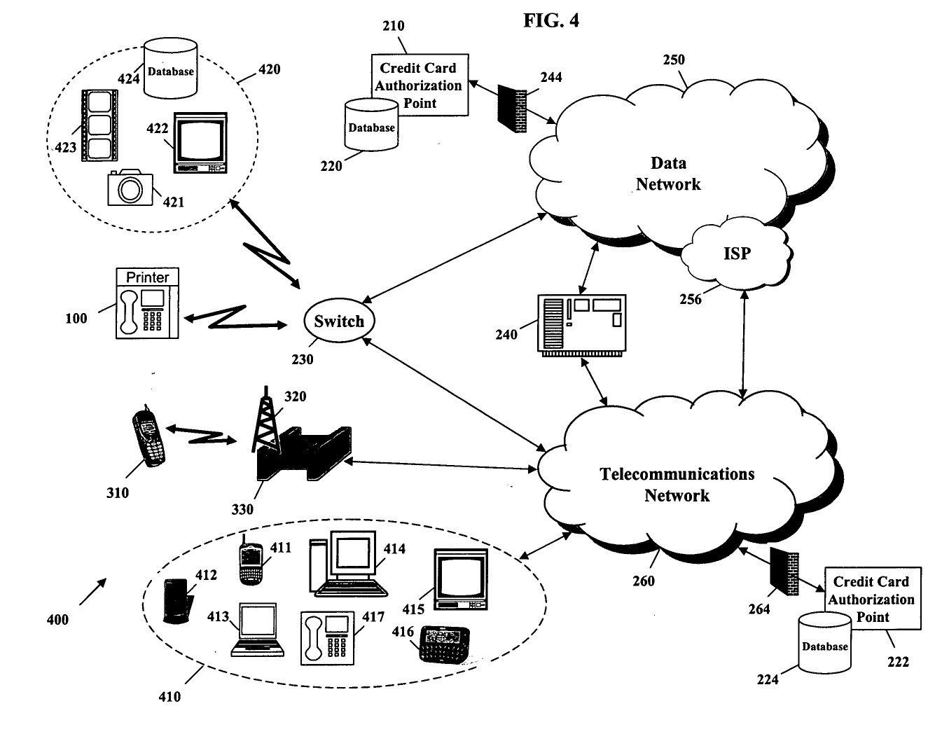

FIGS. 3-4 illustrates other operating environments for monitoring voice/data financial transactions. Operating environment 300 of FIG. 3 is similar to the operating environment 200 of FIG. 2; however, instead of the local, direct communications connection of the voice/data financial transaction communications device 100 with the cardholder and/or third party communications device, operating environment 300 illustrates an alternate communications connection among the voice/data financial transaction communications device 100 and a cardholder and/or third party's cellular telephone 310 via the voice data/switch 230, the telecommunications network 260, a mobile switching telephone office 330, and/or an antenna 320. FIG. 4 illustrates a voice/data financial transaction communication system 400 in an operating environment similar to FIG. 3; however, FIG. 4 further includes additional cardholder and/or third party communications devices 410 including a VoIP phone, a PDA 412, a laptop 413, a computer system 414, an interactive television 415, a pager 416, and a POTS phone 417 and includes peripheral devices 420 including an audio/video recording system 421, another interactive television 422, an archive of audio/video recording data, and a database of other surveillance data 423. In addition, the peripheral devices 420 may include other devices that verify or authenticate a user of the financial card medium (e.g., a bioinformatics device such as a fingerprint device) and/or devices that obtain surveillance data for the financial transaction. The communications switch 230 may include a packet-based “softswitch” that uses software control to provide voice, data, and video services by dynamically changing its connection data rates and protocol types. In this case an application server interfaces with the switch 230 via a packet protocol, such as Session Initiation Protocol (SIP) such that the financial transaction monitoring signal and/or any responses from the cardholder and/or third party are effectively communicated over the communications connection. In addition, the communications switch 230 may include Advanced Intelligent Network (AIN) componetry controlling many features of the communications with the telecommunications network 260. The communications signaling, connections, and/or logic among the communications switch 230, the telecommunications network 260, the data network 250, the Voice XML gateway 240, the ISP 256, the MSTO 330, and/or the antenna 320, however, are well understood in the art and will not be further described.

With a response from the cardholder and/or third party communications device 310 and/or 410 (and/or 210) to request surveillance data, the response is communicated to the VoIP Financial Transaction Monitoring Module (reference numeral 128 of FIG. 1) and the VoIP Financial Transaction Monitoring Module generates a surveillance control signal for communication to the peripheral device 420 to access and/or activate surveillance data, establish a communications connection among the peripheral device, the voice/data financial transaction communications device 100, the credit card authorization point 210 and/or 222, and/or the cardholder and/or third party communications device 310 and/or 410. Thereafter, the cardholder and/or third party communications device 310 and/or 410 present the surveillance data. Thereafter, the cardholder and/or third party may communicate another response to deactivate and/or discontinue the surveillance data of the peripheral device and/or provide an instruction for the financial transaction request (e.g., authorize or deny). According to some embodiments, if the cardholder and/or third party does not deactivate and/or respond to the surveillance data, then the VoIP Financial Transaction Monitoring Module may have a pre-set time limit that times out to deactivate and/or discontinue communication of the surveillance data to the cardholder and/or third party communications device 310 and/or 410. The surveillance data may provide helpful information, such as, for example, a digital photo of a stranger pumping gas to the cardholder and/or third party communications device 310 and/or 410, such that the cardholder and/or third party may provide instructions to deny and/or otherwise cancel the financial transaction request to the financial institution authorization communications address and/or a response from the financial institution authorization communications address. In additional embodiments, further security measures may be installed in the system, such as a security alert communication to confiscate the credit card, to contact an authority (including a name and communications address of the authority), to provide helpful information, and/or to provide a communication to the financial institution authorization communications address to cancel and/or to suspend the account.

According to other embodiments, after the response is received from the third party and/or cardholder communications device 310 and/or 410, then the transaction is further processed and completed. For example, if the cardholder requests to further monitor financial transaction communications, then the financial transaction may proceed until the financial institution authorization communications address communicates an authorization and the transaction is completed. According to a further embodiment, the VoIP Financial Transaction Communications Monitoring Module (shown as reference numeral 128 of FIG. 1) may communicate with a printer of the cardholder and/or third party's communications device 310 and/or 410 to print out a receipt of the transaction and/or an alternative transactional document (e.g., an email, a text message, and so on).

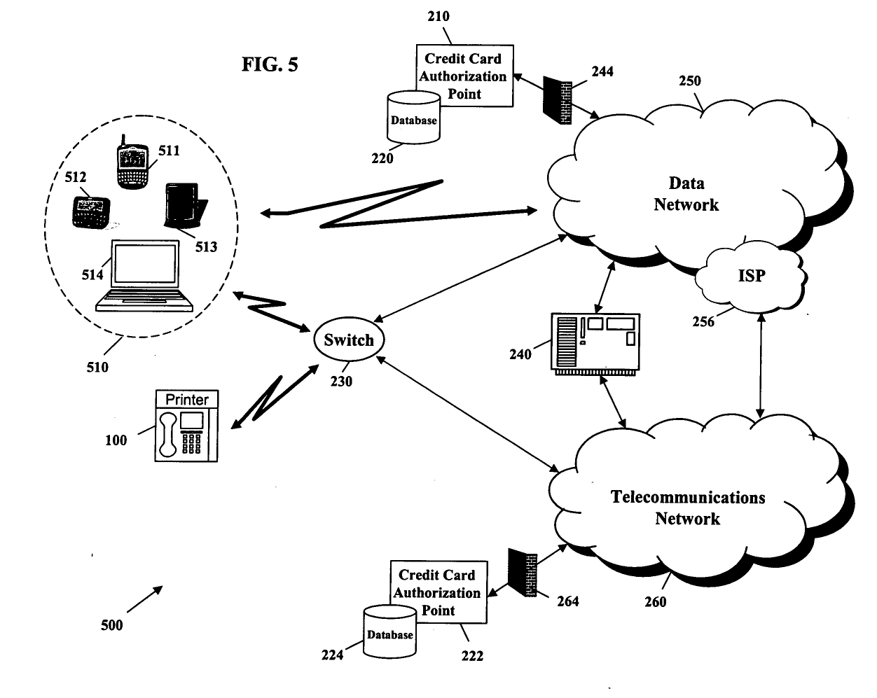

FIG. 5 illustrates another operating environment for monitoring voice/data financial transactions 500 similar to the operating environment 200 of FIG. 2. However, instead of the local, direct communications connection of the voice/data financial transaction communications device 100 with the cardholder and/or third party communications devices 270, operating environment 500 illustrates a communications connection among the voice/data financial transaction communications device 100 and at least one cardholder and/or third party wireless voice/data communications devices 510 via the voice/data switch 230 and/or via the data communications network 250. These cardholder and/or third party wireless voice/data communications devices include VoIP phone 511, pager 512, PDA 513, and laptop 514. Alternate voice/data communications devices (not shown) may also establish a communications connection with the voice/data financial transaction communications device 100 to communicate the financial transaction monitoring signal and/or any responses with the cardholder and/or third party. Similar to the above embodiments, the communications switch 230 may include a packet-based “softswitch” that uses software control to provide voice, data, and video services by dynamically changing its connection data rates and protocol types. In this case an application server interfaces with the switch 230 via a packet protocol, such as Session Initiation Protocol (SIP). The communications signaling, connections, and/or logic among the communications switch 230, the voice/data financial transaction communications device 100, and/or the cardholder and/or third party voice/data communications devices 510, however, are well understood in the art and will not be further described.

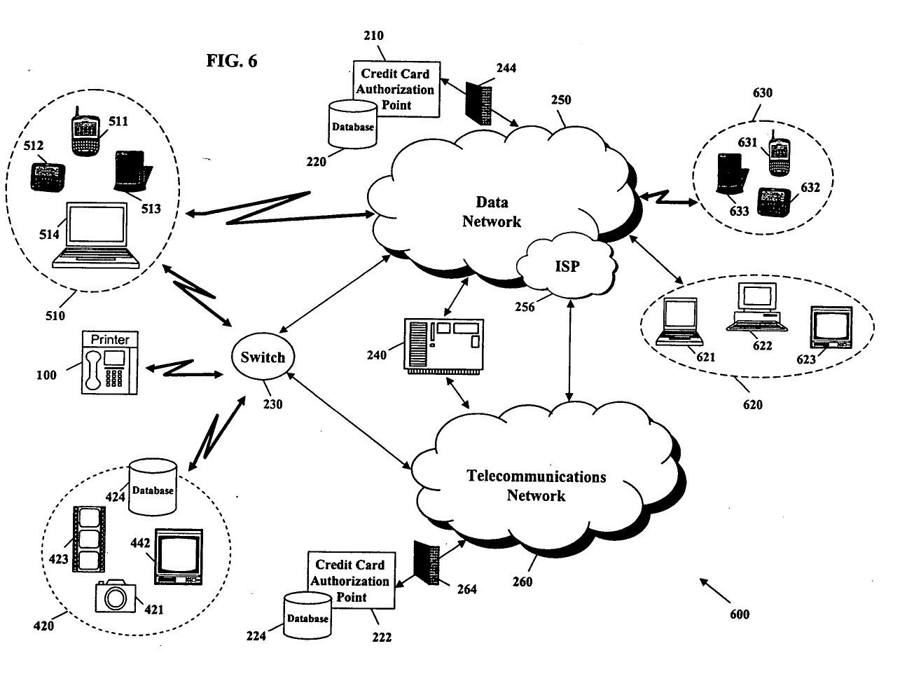

FIG. 6 illustrates another operating environment for monitoring voice/data financial transactions 600 similar to the operating environment 500 of FIG. 5. However, operating environment 600 further includes the peripheral devices 420 including the audio/video recording system 421, the other interactive television 422, the archive of audio/video recording data, and the database of other surveillance data 423 and includes one or more wired cardholder and/or third party communications devices 620 having a wired connection with the data network 250 and one or more other wireless cardholder and/or third party communications devices 630 having another wireless connection with the data network 250. The wired cardholder and/or third party communications devices 620 include a laptop computer 621, a personal computer, and/or an interactive television 623 (typically via a set top box (not shown)). And, the wireless cardholder and/or third party communications devices 630 include a VoIP phone, a pager 632, and/or a PDA 633. Alternatively, some of the wired devices 620 may have a wireless connection (e.g., laptop 621 may communicate via a wireless connection to a component in communication with the data network 250) and some of the wireless devices 630 may have a wired connection to the data network 250. Regardless of the cardholder and/or third party communications device (reference numerals 270, 310, 410, 510, 620, and 630), the voice/data financial transaction communications device 100, the voice/data switch, the data network 250, and/or the telecommunications network 260 enable communications of the financial monitoring communications signal to and/or any response from the cardholder and/or third party communications device (including audio, text (e.g., ASCII), video, other digital formats, and combination thereof). Accordingly, the voice/data financial transaction communications device 100, the voice/data communications switch 230, the data network 250, and/or the telecommunications network 260 may include and/or be coupled with a multi-protocol communications interface that acts as a gateway to enable communications of the financial monitoring signal. For example, if the cardholder and/or third party communications device uses the Wireless Application Protocol (WAP) technique, then the financial monitoring communications signal is communicated using the Wireless Mark-up Language (WML) as known in the art. The Wireless Mark-up Language (WML) and the WAP technique are known and will not be further described. This is a description of a solution for a specific wireless protocol, such as WAP. This solution may be clearly extended to other wireless protocol, such as i-mode, VoiceXML (Voice eXtensible Markup Language), Dual Tone Multi-Frequency (DTMF), and other signaling means.

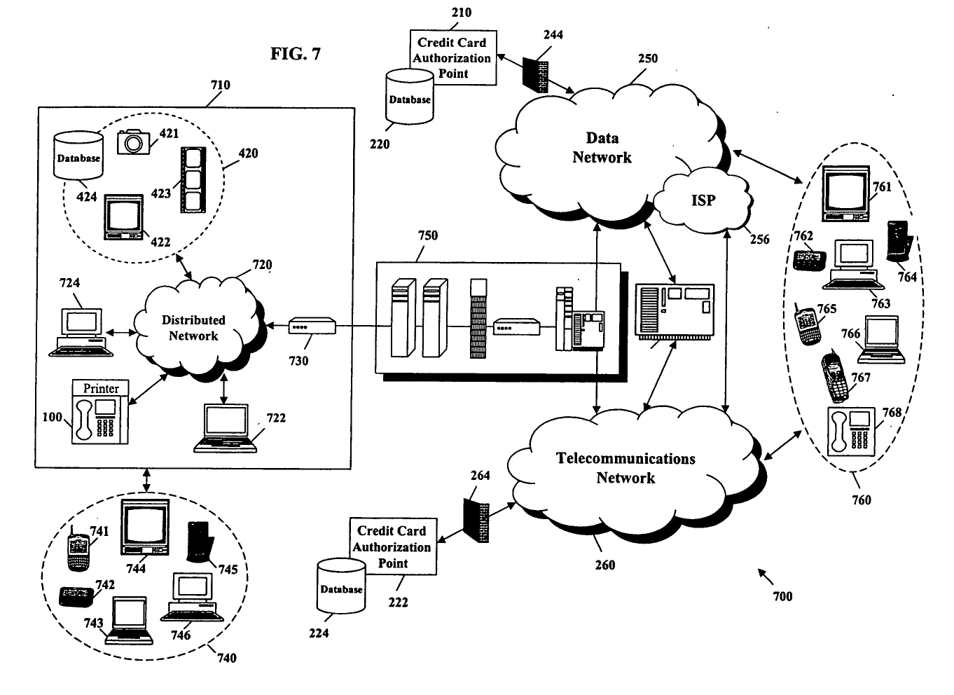

Referring now to FIG. 7, an alternate operating environment for monitoring voice/data financial transactions 700 includes a customer premise network 710 including the voice/data financial transactions communications device 100 of FIG. 1, at least one alternate voice/data financial transaction device shown as a laptop computer 722 and personal computer 724, a distributed network 720 in communication with at least one peripheral device 420, and a customer gateway 730, and includes at least one locally connected cardholder and/or third party voice/data communications devices 740, a call control and service logic system 750, the data communications network 250 communicating over the firewall 244 with the credit card authorization point 210 that includes the database 220, the Internet Service Provider (ISP) 256, the Voice XML Gateway 240, the telecommunications network 260 communicating over the other firewall 264 with the other credit card authorization point 222 that includes the other database 224, and external cardholder and/or third party communications devices 760 that include an interactive television 761, a pager 762, a personal computer 763, a PDA 764, a VoIP phone 765, a laptop computer 766, a cellular phone 767, and/or a POTS phone 768. The locally connected cardholder and/or third party communications devices 740 include a VoIP phone 741, a pager 742, a laptop 743, an interactive television 744, a PDA 745, and/or a computer 746 that communicate either directly with the voice/data communications device 100 (similar to communications with wireless devices 270) or via the distributed network 720 and then to the voice/data financial transaction device 100 (or to alternate computing systems that may include the laptop computer 722 and/or the personal computer 724, peripheral devices 420, and/or gateway 730. While FIG. 7 illustrates the customer premise network 710 with a wired connection to the call control and service logic system 750 via a distributed network 720 and customer gateway 730, the communications connection may be wireless and/or may include alternative components. The distributed network 720 may be a local area network, a wide area network, and/or other networking architects as known in the art. According to embodiments of this invention, the voice/data financial transaction communications device 100, the laptop computer 722, the personal computer 724, and/or the peripheral device(s) 420 communicate with the data network 250 and/or the telecommunications network 260 via the call control and service logic system 750. The customer gateway 730 communicates with a gateway of the call control and service logic system 750 to connect the customer premise network 710 and the call control and service logic system 750. The customer gateway 730, gateway of the call control and service logic system 750, and other gateways will not be further explained as their functions are known in the art. The call control and service logic system 750 acts as a “middleman” that enables communications between the voice/data financial transaction communications device 100, the laptop computer 722, the personal computer 724, and/or the peripheral device(s) 420 with the credit card authorization point 210 of the data communications network 250, the credit card authorization point 222 of the telecommunications network 260, and/or the external cardholder and/or third party communications devices 760. According to embodiments of this invention, the call control and service logic system 750 communicates with the data communications network 250 and/or the telecommunications network 260 via an integrated communications switch of the call control and service logic system 750. This communications switch of the call control and service logic system 750 may include a packet-based “softswitch” that uses software control to provide voice, data, and video services by dynamically changing its connection data rates and protocol types. In this case an application server interfaces with the switch via a packet protocol, such as Session Initiation Protocol (SIP) or H.323. In addition, the communication switch of the call control and service logic system 750 may include Advanced Intelligent Network (AIN) componetry controlling many features of the communications with the telecommunications network 260. The communications signaling, connections, and/or logic amongst the call control and service logic system 750, the data network 250, the Voice XML gateway 240, the ISP 256, and/or the telecommunications network 260, however, are well understood in the art and will not be further described. By way of example, the locally connected communications device may be a college student's VoIP phone 741 (e.g., a third party communications device) and the external cardholder communications device may be a parent's cellular phone 767 such that when the college student uses his/her parent's credit card for a financial transaction, the financial monitoring communications signal is communicated with the college student's VoIP phone 741 and the parent's cellular phone 767, and, if requested, a communications connection may be established between the two communications devices 741, 767 so that the parent can discuss the purchase with his/her child before authorizing or otherwise responding to the financial transaction monitoring communications signal.

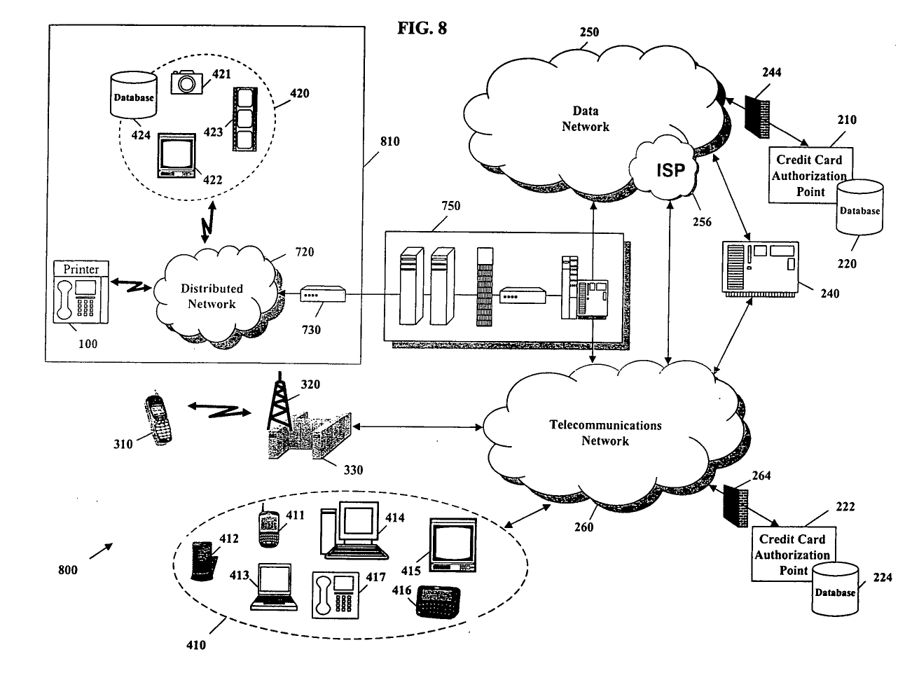

FIG. 8 illustrates another voice/data financial transaction monitoring communications operating environment 800 similar to the operating environment 400 of FIG. 4; however, operating environment 800 includes a customer premise network 810 (similar to customer premise network 710 of FIG. 7) and the call control and service logic system 750 described in FIG. 7. FIG. 8 provides an example a cardholder cellular phone 310 in communication with the telecommunications network 260 via antenna 320, MSTO 330 and another cardholder communications device, such as POTS phone 417, in communication with the telecommunications network 260, such that the cellular phone 310 and POTS phone 417 may establish a communications connection with each other, with the voice/data financial transaction communications device 100, and/or with credit card authorization point 210 and/or 222.

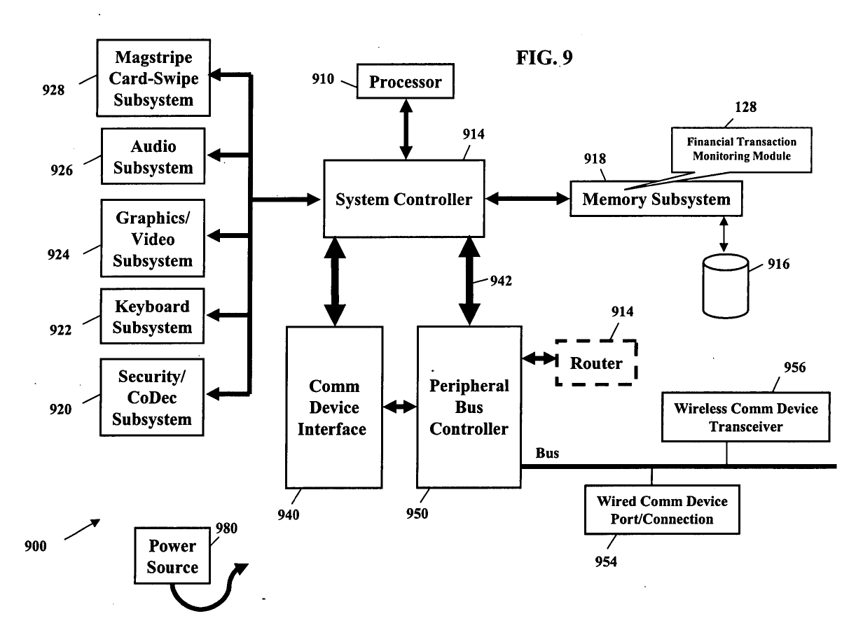

FIG. 9 depicts another block diagram of the VoIP Financial Transaction Monitoring Module 128 residing in an alternate computer system shown as voice/data financial transactions communications device 900. As FIG. 9 shows, the VoIP Financial Transaction Monitoring Module 128 operates within a system memory device. The VoIP Financial Transaction Monitoring Module 128, for example, is shown residing in a memory subsystem 918. The VoIP Financial Transaction Monitoring Module 128, however, could also reside in a peripheral storage device 916. The voice/data financial transaction communications device 900 also has one or more central processors 910 executing an operating system. The operating system, as is well known in the art, has a set of instructions that control the internal functions of the voice/data financial transaction communications device 900. A communications interface 940 communicates signals, data signals, control signals, and address signals, between the central processor 910 and a system controller 914 (typically called a “Northbridge”). Additionally, the communications interface 940 has a means to communicate the communications signal between the voice/data financial transaction communications device 900 and a communications network.

The system controller 914 provides a bridging function between the one or more central processors 914, a video/graphics subsystem 924, a keyboard subsystem 922, an audio subsystem 926, a magstripe card swipe subsystem 928, a security/CoDec subsystem 920, the memory subsystem 918, a PCI (Peripheral Controller Interface) bus 950, and a Communications (“Comm”) Device Interface 940. The PCI bus 942 is controlled by a Peripheral Bus Controller 950. The Peripheral Bus Controller 950 (typically called a “Southbridge”) is an integrated circuit that serves as an input/output hub for a router 960 and for various peripheral ports and/or transceivers. The router 960 (which may or may not be incorporated into the voice/data financial transaction communications device 900), operates with the peripheral bus controller 950 to allow for communications with a communications network (e.g., routing a financial transaction request to the credit card authorization address). The peripheral ports allow the voice/data financial transaction communications device 900 to communicate with a variety of devices through networking ports (such as SCSI or Ethernet, not shown) and/or transceivers that include Wireless Communications (“Comm”) Device Transceiver 956 (for communication of any frequency signal in the electromagnetic spectrum, such as, for example, Wireless 802.11 and Infrared) and Wired Communications (“Comm”) Device Port/Connection 954 (such as modem V90+ and compact flash slots). These peripheral ports could also include other networking ports, such as, a serial port (not shown) and/or a parallel port (not shown). In another embodiment, the voice/data financial transaction communications device 900 may include a power source 980, such as a rechargeable battery to provide power and allow the voice/data financial transaction communications device 900 to be portable. In alternate embodiments, the router 960, if incorporated into the device, may be an alternative router known by those of ordinary skill in the art. Additionally, those of ordinary skill in the art understand that the program, processes, methods, and systems described in this patent are not limited to any particular computer system or computer hardware.

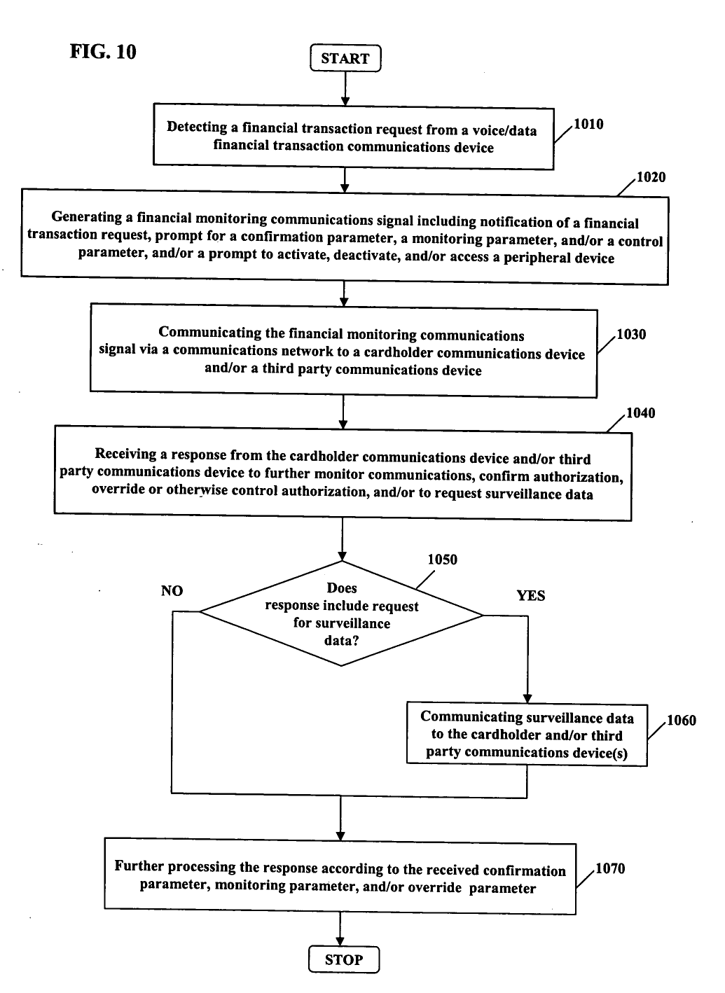

FIG. 10 illustrates a flowchart of a method for providing voice/data financial transaction monitoring communications according to some of the exemplary embodiments of this invention. Initially, a financial transaction request is detected from a voice/data financial transaction communications device [block 1010] and is used to generate a financial transaction monitoring communications signal [block 1020]. The financial transaction monitoring signal may include the financial transaction request, a confirmation parameter, a monitoring parameter, a control parameter, a peripheral communications parameter, and/or another parameter for processing the financial transaction. Thereafter, the financial monitoring communications signal is communicated via a communications network to a cardholder communications device and/or a third party communications device [block 1030]. A response is then received from the cardholder communications device and/or a third party communications device to confirm the authorization, monitor communications, override an authorization or otherwise control a response from a financial institution, request surveillance data, and/or otherwise further process the financial transaction [block 1040]. The method continues with a determination whether the response includes a request for surveillance data [block 1050]. If there is a request for surveillance data, then a peripheral device is accessed and/or otherwise activated and surveillance data is communicated to the cardholder and/or third party communications device [block 1060] and the response is further processed according to any other responses [block 1070]. However, if the response does not include a request for surveillance data, then the response (if any) is processed according to the received confirmation parameter, override and/or control parameter, monitoring parameter, and/or another financial transaction processing parameter [block 1070].

The VoIP Financial Transaction Monitoring Module may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the VoIP Financial Transaction Monitoring Module to be easily disseminated.

The VoIP FinanciaL Transaction Monitoring Module may be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol phone, or a wireless pager.

While this invention has been described with respect to various features, aspects, and embodiments, those skilled and unskilled in the art will recognize this invention is not so limited. Other variations, modifications, and alternative embodiments may be made without departing from the spirit and scope of this invention.

What is claimed is:

1. A method, comprising the following steps:
receiving a financial transaction request from a voice/data communications device to a financial institution authorization communications address, the financial transaction request comprising at least one of a financial institution authorization communications address, a card identifier, an expiration date, a monetary limit for a financial transaction, a cardholder identifier, a cardholder communications address, a third party identifier, a third party communications address, merchant data, a merchandise identifier, a service identifier, and a monetary amount;
generating a financial monitoring communications signal comprising at least one of (1) the financial transaction request, (2) a confirmation parameter to confirm an authorization from the financial institution authorization communications address, (3) a monitoring parameter for monitoring communications among the voice/data communications device and the financial institution authorization communications address, (4) a control parameter for overriding the authorization from the financial institution authorization communications address, and (5) a peripheral communications parameter for communicating with a peripheral device; and
communicating the financial monitoring communications signal to at least one of a cardholder communications device associated with the cardholder communications address and a third party communications device associated with the third party communications address.

2. The method of claim 1, wherein the step of communicating the financial monitoring communications signal to at least one of the cardholder communications device and the third party communications device comprises communicating the financial monitoring communications signal via at least one of a telecommunications network, a satellite network, a private branch exchange network, a data network, and a mobile switching telephone network.

3. The method according to claim 1, further comprising the step of:
in response to communicating the financial monitoring communications signal, receiving a response comprising at least one of (1) a confirmation of the authorization, (2) a selection for monitoring communications with the financial institution authorization communications address, (3) an override instruction to cancel the authorization, and (4) a surveillance request to communicate surveillance data of the peripheral device.

4. The method according to claim 3, further comprising the step of:
in response to the surveillance request, communicating the surveillance data of the peripheral device to at least one of the cardholder communications device and the third party communications device.

5. The method of claim 4, wherein the step of communicating the surveillance data to at least one of the cardholder communications device and the third party communications device comprises communicating the surveillance data via at least one of a telecommunications network, a satellite network, a private branch exchange network, a data network, and a mobile switching telephone network.

6. The method according to claim 1, wherein the voice/data communications device comprises at least one of a wireless communications device, a voice-over internet protocol phone, a pager, a computer, a digital music device, a digital recording device, a personal digital assistant, an interactive television, and a digital signal processor.

7. The method according to claim 1, further comprising the step of:
using the financial monitoring communications signal to control at least one of communications with, access to, activation of, deactivation of, and monitoring of the peripheral device.

8. A communications system comprising:
a voice/data financial transaction communications device having a card reader subsystem for reading a financial transaction medium, a Voice-over Internet Protocol Financial Transaction Monitoring Module stored in a memory device, and a processor communicating with the memory device,
the Voice-over Internet Protocol Financial Transaction Monitoring Module,
detecting a financial transaction request from the voice/data communications device to a financial institution authorization communications address, the financial transaction request comprising at least one of a financial institution authorization communications address, a card identifier, an expiration date, a monetary limit for a financial transaction, a cardholder identifier, a cardholder communications address, a third party identifier, a third party communications address, merchant data, a merchandise identifier, a service identifier, and a monetary amount,
generating a financial monitoring communications signal comprising at least one of (1) the financial transaction request, (2) a confirmation parameter to confirm an authorization from the financial institution authorization communications address, (3) a monitoring parameter for monitoring communications among the voice/data communications device and the financial institution authorization communications address, (4) a control parameter for overriding the authorization from the financial institution authorization communications address, (5) a peripheral communications parameter for communicating with a peripheral device, (6) a third party communications parameter for communicating with another third party communications device, (7) a cardholder communications parameter for communicating with another cardholder communications device; and
a communications network for establishing a communications connection among at least two of the voice/data financial transaction communications device, a cardholder communications device, a third party communications device, the financial institution authorization communications device, and the peripheral device,
wherein the cardholder communications device is associated with the cardholder communications address, wherein the third party communications device is associated with the third party communications address, and wherein the financial institution authorization communications device is associated with the financial institution authorization communications address.

9. The communications system according to claim 8, the Voice-over Internet Protocol Financial Transaction Monitoring Module further:
receiving an authorization from the financial institution authorization communications address for the requested monetary amount, and
receiving a response comprising at least one of (1) confirmation of the authorization, (2) selection for monitoring communications with the financial institution authorization communications address, (3) override instruction to cancel the authorization, (4) surveillance request to communicate surveillance data of the peripheral device, and (5) communications request with another communications device.

10. The communications system according to claim 8, the Voice-over Internet Protocol Financial Transaction Monitoring Module further:
communicating the surveillance data of the peripheral device to at least one of the cardholdet communications device associated with the cardholder communications address and the third party communications device associated with the third party communications address.

11. The communications system according to claim 8, the voice/data financial transaction communications device further comprising a router for transceiving communications signals with the communications network.

12. The communications system according to claim 8, wherein the communications network comprises at least one of a telecommunications network, a satellite network, a private branch exchange network, a data network, and a mobile switching telephone network.

13. The communications system according to claim 8, the voice/data financial transaction communications device further comprising means for communicating with a call control and service logic system, the call control and service logic system establishing a communications connection with the communications network.

14. The communications system according to claim 13, wherein the voice/data financial transaction communications device comprises a voice/data financial transaction communications device of a distributed network.

15. The communications system according to claim 13, wherein the call control and service logic system comprises an Internet Protocol Centrex system.

16. The communications system of claim 13, wherein the call control and service logic system comprises a voice and data switch, the voice and data switch establishing a communications connection with at least one of a telecommunications network and a data network.

17. The system of claim 8, wherein the financial transaction medium data further comprises an identifier of a third party, a parameter for presenting a notification of an incoming financial transaction communication, and a financial transaction control parameter.

18. The communications system of claim 8, wherein the peripheral device comprises at least one of a security system, a lighting control system, an audio distribution system, a multimedia-on-demand system, an appliance system, an environmental management system, a communications system, a visual monitoring system, a medical device, a positioning system, and an information management system, wherein at least one of the communications network and the voice/data communications device communicates a peripheral control signal with the peripheral device.

19. A computer program product, comprising:
a computer-readable medium; and
a Financial Transaction Monitoring Module stored on the computer-readable medium, the Financial Transaction Monitoring Module,
detecting a financial transaction request to a financial institution authorization communications address via a communications network, the financial transaction request comprising at least one of a financial institution authorization communications address, a card identifier, an expiration date, a monetary limit for a financial transaction, a cardholder identifier, a cardholder communications address, a third party identifier, a third party communications address, merchant data, a merchandise identifier, a service identifier, and a monetary amount,
generating a financial monitoring communications signal comprising at least one of (1) the financial transaction request, (2) a confirmation parameter to confirm an authorization from the financial institution authorization communications address, (3) a monitoring parameter for monitoring communications among the voice/data communications device and the financial institution authorization communications address, (4) a control parameter for overriding the authorization from the financial institution authorization communications address, (5) a peripheral communications parameter for communicating with a peripheral device, (6) a third party communications parameter for communicating with another third party communications device, (7) a cardholder communications parameter for communicating with another cardholder communications device,
wherein the financial monitoring communications signal is communicated to at least one of a cardholder communications device associated with the cardholder communications address and a third party communications device associated with the third party communications address.

20. The computer program product of claim 19, wherein the computer-readable medium is stored to at least one of a voice/data financial transaction communications device, a communications network, and a computer system of a financial institution associated with the financial institution authorization communications address.
